(19) United States
(12) Patent Application Publication
(10) Pub. No.: US 2012/0230370 A1
(43) Pub. Date: Sep. 13, 2012

(54) Efficient Transmission of Large Messages in Wireless Networks

(75) Inventors: Shmuel Shaffer, Palo Alto, CA (US); Sandeep Jay Shetty, San Jose, CA (US); Jean-Philippe Vasseur, Saint Martin d'Uriage (FR)

(73) Assignee: CISCO TECHNOLOGY INC., San Jose, CA (US)

(21) Appl. No.: 13/043,156

(22) Filed: Mar. 8, 2011

(51) Int. Cl. H04B 1/713

(52) U.S. Cl. 375/133; 375/E01.033

(57) ABSTRACT

In one embodiment, a sender in a frequency hopping wireless network classifies a message as a large message to be fragmented into a plurality of packets for transmission to a receiver, and in response, indicates to the receiver that the message is a large message to request use of an orthogonal frequency hopping sequence between the sender and receiver for the duration of the large message transmission, the orthogonal frequency hopping sequence orthogonal to a shared frequency hopping sequence of the wireless network. Thereafter, the sender transmits the large message to the receiver on the orthogonal frequency hopping sequence, and returns to the shared frequency hopping sequence upon completion. In another embodiment, the receiver receives the indication that a message is a large message (requesting use of the orthogonal frequency hopping sequence). If the receiver can comply, the large message is received on the orthogonal frequency hopping sequence.

### TECHNICAL FIELD

The present disclosure relates generally to wireless communication, and, more particularly, to frequency hopping in wireless networks.

### BACKGROUND

In frequency hopping wireless networks, time frames are divided into regular timeslots, each one operating on a different frequency. A reference clock may be provided for the time frames for an entire network (e.g., mesh/cell), and a media access control (MAC) layer of each node divides time into timeslots that are aligned with the timeslot boundary of its neighbor (e.g., parent node). Also, each timeslot may be further divided into sub-timeslots, e.g., 6, 8, or 12 sub-timeslots within a timeslot. Illustratively, the MAC layer is in charge of scheduling the timeslot in which a packet is sent, the main objective of which being randomization of the transmission time in order to avoid collisions with neighbors' packets.

The length of data messages transmitted may vary according to the size of the information to be relayed. In particular, while most messages are short (e.g., shorter than a timeslot), when a large message needs to be sent either to or from a wireless node, the Network or MAC layer fragments the long message into smaller packets and transmits each fragment as a packet over the air. Since wireless mesh networks are prone to collisions, it is more difficult and inefficient to transmit large messages, as each of the packet fragments have a chance of collision, loss, etc. Further, since the start of packet transmissions are randomized as noted above, this delay may further reduce the efficiency of air time utilization and may delay the delivery of the overall message.

### BRIEF DESCRIPTION OF THE DRAWINGS

The embodiments herein may be better understood by referring to the following description in conjunction with the accompanying drawings in which like reference numerals indicate identically or functionally similar elements, of which:

FIG. 1 illustrates an example wireless network;

FIG. 2 illustrates an example wireless device/node;

FIG. 3 illustrates an example wireless message/packet;

FIG. 4 illustrates an example topology management message;

FIG. 5 illustrates an example directed acyclic graph (DAG) in the wireless network of FIG. 1;

FIG. 6 illustrates an example frequency hopping sequence;

FIGS. 7A-B illustrate example large messages;

FIG. 8 illustrates an example parent change in the DAG of FIG. 4;

FIG. 9 illustrates an example orthogonal frequency hopping sequence;

FIG. 10 illustrates an example large message transmission in an orthogonal frequency hopping sequence;

FIG. 11 illustrates an example pause during a large message transmission;

FIG. 12 illustrates an example collision during a large message transmission; and

FIGS. 13A-B illustrate an example simplified procedure for efficient transmission of large messages in wireless networks through the use of on-demand orthogonal frequency hopping sequences.

### DESCRIPTION OF EXAMPLE EMBODIMENTS

### Overview

According to one or more embodiments of the disclosure, a sender in a frequency hopping wireless network classifies a message as a large message to be fragmented into a plurality of packets for transmission to a receiver, and in response, indicates to the receiver that the message is a large message to request use of an orthogonal frequency hopping sequence between the sender and receiver for the duration of the large message transmission, the orthogonal frequency hopping sequence orthogonal to a shared frequency hopping sequence of the wireless network. Thereafter, the sender transmits the large message to the receiver on the orthogonal frequency hopping sequence, and returns to the shared frequency hopping sequence upon completion of the large message transmission.

According to one or more additional embodiments of the disclosure, a receiver in a frequency hopping wireless network receives an indication that a message from a sender is a large message, the indication to request use of the orthogonal frequency hopping sequence. If the receiver can comply, the large message is received on the orthogonal frequency hopping sequence, and the receiver returns to the shared frequency hopping sequence upon completion of the large message transmission.

### Description

A network is a geographically distributed collection of nodes interconnected by communication links and segments for transporting data between end nodes, such as personal computers and workstations, or other devices, such as radios, sensors, etc. Many types of computer networks are available, with the types ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, or Powerline Communications (PLC) such as IEEE 61334, IEEE P1901.2, and others.

A wireless network, in particular, is a type of shared media network where a plurality of nodes communicate over a wireless medium, such as using radio frequency (RF) transmission through the air. For example, a Mobile Ad-Hoc Network (MANET) is a kind of wireless ad-hoc network, which is generally considered a self-configuring network of mobile routes (and associated hosts) connected by wireless links, the union of which forms an arbitrary topology. For instance, Low power and Lossy Networks (LLNs), e.g., certain sensor networks, may be used in a myriad of applications such as for “Smart Grid” and “Smart Cities,” and may often consist of wireless nodes in communication within a field area network (FAN). LLNs are generally considered a class of network in which both the routers and their interconnect are constrained: LLN routers typically operate with constraints, e.g., processing power, memory, and/or energy (battery), and their interconnects are characterized by, illustratively, high loss rates, low data rates, and/or instability. LLNs are comprised of anything from a few dozen and up to thousands or even millions of LLN routers, and support point-to-point traffic (between devices inside the LLN), point-to-multipoint traffic (from a central control point to a subset of devices inside the LLN) and multipoint-to-point traffic (from devices inside the LLN towards a central control point).

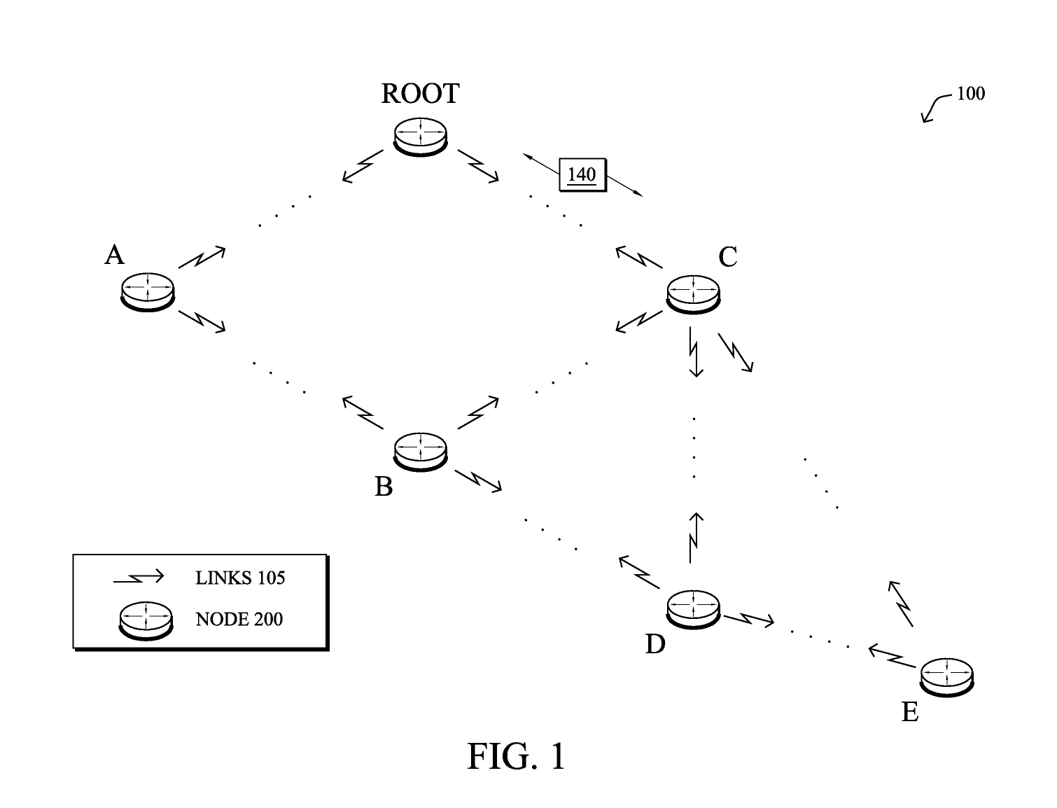

FIG. 1 is a schematic block diagram of an example wireless network 100 (e.g., computer network, communication network, etc.) illustratively comprising nodes/devices 200 (e.g., labeled as shown, “ROOT” “A,” “B,” “C,” “D,” and “E”) interconnected by wireless communication (links 105). In particular, certain nodes 200, such as, e.g., routers, sensors, computers, radios, etc., may be in communication with other nodes 200, e.g., based on distance, signal strength, current operational status, location, etc. Those skilled in the art will understand that any number of nodes, devices, links, etc. may be used in the wireless network, and that the view shown herein is for simplicity (particularly, that while routers are shown, any wireless communication devices A-E may be utilized). Also, while the embodiments are shown herein with reference to a generally wireless network, the description herein is not so limited, and may be applied to networks that have wired and wireless links.

Data transmissions 140 (e.g., traffic, packets, messages, etc. sent between the devices/nodes) may be exchanged among the nodes/devices of the computer network 100 using predefined network communication protocols such as certain known wireless protocols (e.g., IEEE Std. 802.15.4, WiFi, Bluetooth®, etc.) or other shared media protocols where appropriate. As described herein, the communication may be based on a frequency hopping protocol. In this context, a protocol consists of a set of rules defining how the nodes interact with each other.

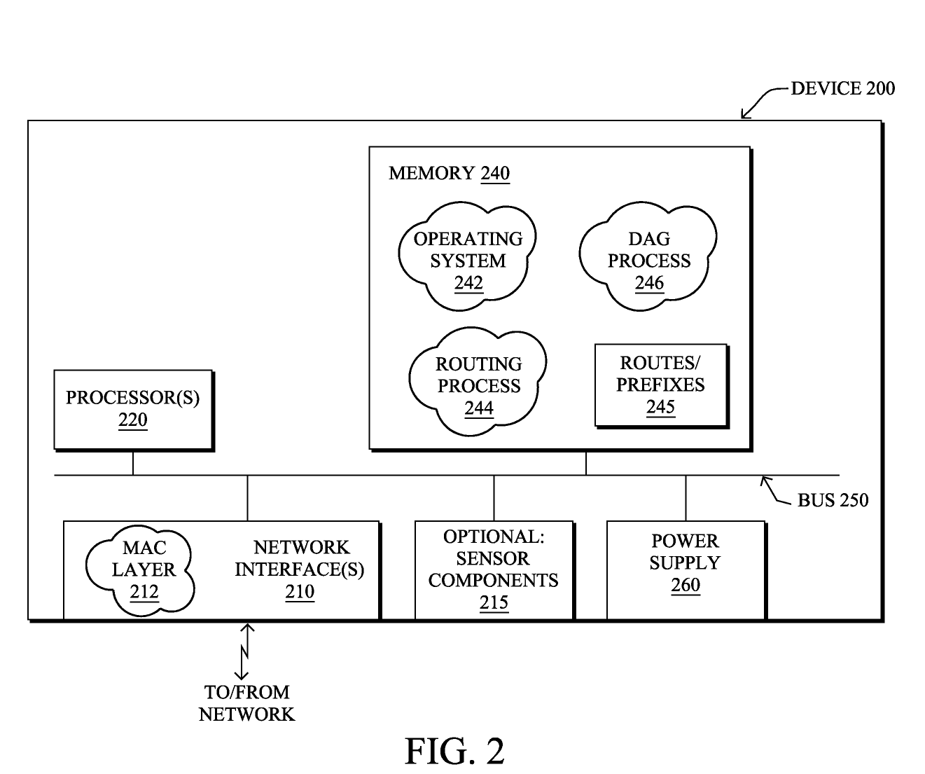

FIG. 2 is a schematic block diagram of an example node/device 200 that may be used with one or more embodiments described herein, e.g., as nodes A-E and ROOT. The device may comprise one or more wireless network interfaces 210, an optional sensor component 215 (e.g., for sensor network devices), at least one processor 220, and a memory 240 interconnected by a system bus 250, as well as a power supply 260 (e.g., battery, plug-in, etc.).

The wireless network interface(s) 210 contain the mechanical, electrical, and signaling circuitry for communicating data over wireless links 105 coupled to the network 100. The network interfaces may be configured to transmit and/or receive data using a variety of different wireless communication protocols as noted above and as will be understood by those skilled in the art. In addition, the interfaces 210 may comprise an illustrative media access control (MAC) layer module 212 (and other layers, such as the physical or “PHY” layer, as will be understood by those skilled in the art). Note, further, that the nodes may have two different types of network connections 210, namely, wireless and wired/physical connections, and that the view herein is merely for illustration.

The memory 240 comprises a plurality of storage locations that are addressable by the processor 220 and the network interfaces 210 for storing software programs and data structures associated with the embodiments described herein. Note that certain devices may have limited memory or no memory (e.g., no memory for storage other than for programs/processes operating on the device). The processor 220 may comprise necessary elements or logic adapted to execute the software programs and manipulate the data structures, such as routes or prefixes 245 (notably on capable devices only). An operating system 242, portions of which are typically resident in memory 240 and executed by the processor, functionally organizes the device by, inter alia, invoking operations in support of software processes and/or services executing on the device. These software processes and/or services may comprise routing process/services 244, which may include an illustrative directed acyclic graph (DAG) process 246.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process).

Routing process (services) 244 contains computer executable instructions executed by the processor 220 to perform functions provided by one or more routing protocols, such as proactive or reactive routing protocols as will be understood by those skilled in the art. These functions may, on capable devices, be configured to manage a routing/forwarding table 245 containing, e.g., data used to make routing/forwarding decisions. In particular, in proactive routing, connectivity is discovered and known prior to computing routes to any destination in the network, e.g., link state routing such as Open Shortest Path First (OSPF), or Intermediate-System-to-Intermediate-System (ISIS), or Optimized Link State Routing (OLSR). Reactive routing, on the other hand, discovers neighbors (i.e., does not have an a priori knowledge of network topology), and in response to a needed route to a destination, sends a route request into the network to determine which neighboring node may be used to reach the desired destination. Example reactive routing protocols may comprise Ad-hoc On-demand Distance Vector (AODV), Dynamic Source Routing (DSR), DYnamic MANET On-demand Routing (DYMO), etc. Notably, on devices not capable or configured to store routing entries, routing process 244 may consist solely of providing mechanisms necessary for source routing techniques. That is, for source routing, other devices in the network can tell the less capable devices exactly where to send the packets, and the less capable devices simply forward the packets as directed.

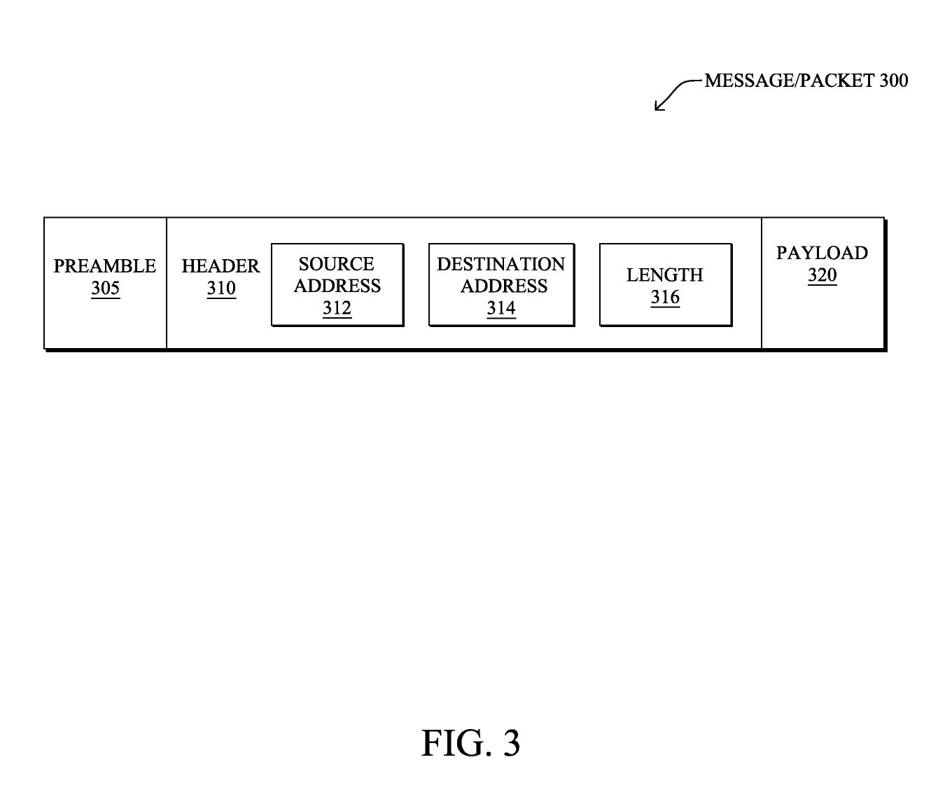

FIG. 3 illustrates an example simplified message/packet format 300 that may be used to communicate information between devices 200 in the network. For example, message 300 illustratively comprises a header 310 with one or more fields such as a source address 312, a destination address 314, and a length field 316, as well as other fields, such as Cyclic Redundancy Check (CRC) error-detecting code to ensure that the header information has been received uncorrupted, as will be appreciated by those skilled in the art. Within the body/payload 320 of the message may be any information to be transmitted, such as user data, control-plane data, etc. In certain embodiments herein, the message payload 320 may comprise specific information that may be carried within one or more type-length-value (TLV) fields as described herein. In addition, based on certain wireless communication protocols, a preamble 305 may precede the message 300 in order to allow receiving devices to acquire the transmitted message, and synchronize to it, accordingly.

As mentioned above, Low power and Lossy Networks (LLNs), e.g., certain sensor networks, may be used in a myriad of applications such as for “Smart Grid” and “Smart Cities.” A number of challenges in LLNs have been presented, such as:

1) Links are generally lossy, such that a Packet Delivery Rate/Ratio (PDR) can dramatically vary due to various sources of interferences, e.g., considerably affecting the bit error rate (BER);

2) Links are generally low bandwidth, such that control plane traffic must generally be bounded and negligible compared to the low rate data traffic;

3) There are a number of use cases that require specifying a set of link and node metrics, some of them being dynamic, thus requiring specific smoothing functions to avoid routing instability, considerably draining bandwidth and energy;

4) Constraint-routing may be required by some applications, e.g., to establish routing paths that will avoid non-encrypted links, nodes running low on energy, etc.;

5) Scale of the networks may become very large, e.g., on the order of several thousands to millions of nodes; and

6) Nodes may be constrained with a low memory, a reduced processing capability, a low power supply (e.g., battery).

In other words, LLNs are a class of network in which both the routers and their interconnects are constrained: LLN routers typically operate with constraints, e.g., processing power, memory, and/or energy (battery), and their interconnects are characterized by, illustratively, high loss rates, low data rates, and/or instability. LLNs are comprised of anything from a few dozen and up to thousands or even millions of LLN routers, and support point-to-point traffic (between devices inside the LLN), point-to-multipoint traffic (from a central control point to a subset of devices inside the LLN) and multipoint-to-point traffic (from devices inside the LLN towards a central control point).

An example protocol specified in an Internet Engineering Task Force (IETF) Internet Draft, entitled “RPL: IPv6 Routing Protocol for Low Power and Lossy Networks” <draft-ietf-roll-rpl-18> by Winter, at al. (Feb. 4, 2011 version), provides a mechanism that supports multipoint-to-point (MP2P) traffic from devices inside the LLN towards a central control point (e.g., LLN Border Routers (LBRs) or “root nodes/devices” generally), as well as point-to-multipoint (P2MP) traffic from the central control point to the devices inside the LLN (and also point-to-point, or “P2P” traffic). RPL (pronounced “ripple”) may generally be described as a distance vector routing protocol that builds a Directed Acyclic Graph (DAG) for use in routing traffic/packets 140, in addition to defining a set of features to bound the control traffic, support repair, etc.

A DAG is a directed graph having the property that all edges are oriented in such a way that no cycles (loops) are supposed to exist. All edges are contained in paths oriented toward and terminating at one or more root nodes (e.g., “clusterheads or “sinks”), often to interconnect the devices of the DAG with a larger infrastructure, such as the Internet, a wide area network, or other domain. In addition, a Destination Oriented DAG (DODAG) is a DAG rooted at a single destination, i.e., at a single DAG root with no outgoing edges. A “parent” of a particular node within a DAG is an immediate successor of the particular node on a path towards the DAG root, such that the parent has a lower “rank” than the particular node itself, where the rank of a node identifies the node's position with respect to a DAG root (e.g., the farther away a node is from a root, the higher is the rank of that node). Further, in certain embodiments, a sibling of a node within a DAG may be defined as any neighboring node which is located at the same rank within a DAG. Note that siblings do not necessarily share a common parent, and routes between siblings are generally not part of a DAG since there is no forward progress (their rank is the same). Note also that a tree is a kind of DAG, where each device/node in the DAG generally has one parent or one preferred parent.

DAGs may generally be built based on an Objective Function (OF). The role of the Objective Function is generally to specify rules on how to build the DAG (e.g. number of parents, backup parents, etc.).

In addition, one or more metrics/constraints may be advertised by the routing protocol to optimize the DAG against. Also, the routing protocol allows for including an optional set of constraints to compute a constrained path, such as if a link or a node does not satisfy a required constraint, it is “pruned” from the candidate list when computing the best path. (Alternatively, the constraints and metrics may be separated from the OF.) Additionally, the routing protocol may include a “goal” that defines a host or set of hosts, such as a host serving as a data collection point, or a gateway providing connectivity to an external infrastructure, where a DAG's primary objective is to have the devices within the DAG be able to reach the goal. In the case where a node is unable to comply with an objective function or does not understand or support the advertised metric, it may be configured to join a DAG as a leaf node. As used herein, the various metrics, constraints, policies, etc., are considered “DAG parameters.”

Illustratively, example metrics used to select paths (e.g., preferred parents) may comprise cost, delay, latency, bandwidth, estimated transmission count (ETX), etc., while example constraints that may be placed on the route selection may comprise various reliability thresholds, restrictions on battery operation, multipath diversity, bandwidth requirements, transmission types (e.g., wired, wireless, etc.). The OF may provide rules defining the load balancing requirements, such as a number of selected parents (e.g., single parent trees or multi-parent DAGs). Notably, an example for how routing metrics and constraints may be obtained may be found in an IETF Internet Draft, entitled “Routing Metrics used for Path Calculation in Low Power and Lossy Networks” <draft-ietf-roll-routing-metrics-18> by Vasseur, et al. (Feb. 22, 2011 version). Further, an example OF (e.g., a default OF) may be found in an IETF Internet Draft, entitled “RPL Objective Function 0” <draft-ietf-roll-of0-05> by Thubert (Jan. 5, 2011 version).

Building a DAG may utilize a discovery mechanism to build a logical representation of the network, and route dissemination to establish state within the network so that routers know how to forward packets toward their ultimate destination. Note that a “router” refers to a device that can forward as well as generate traffic, while a “host” refers to a device that can generate but does not forward traffic. Also, a “leaf” may be used to generally describe a non-router that is connected to a DAG by one or more routers, but cannot itself forward traffic received on the DAG to another router on the DAG. Control messages may be transmitted among the devices within the network for discovery and route dissemination when building a DAG.

According to the illustrative RPL protocol, a DODAG Information Object (DIO) is a type of DAG discovery message that carries information that allows a node to discover a RPL Instance, learn its configuration parameters, select a DODAG parent set, and maintain the upward routing topology. In addition, a Destination Advertisement Object (DAO) is a type of DAG discovery reply message that conveys destination information upwards along the DODAG so that a DODAG root (and other intermediate nodes) can provision downward routes. A DAO message includes prefix information to identify destinations, a capability to record routes in support of source routing, and information to determine the freshness of a particular advertisement. Notably, “upward” or “up” paths are routes that lead in the direction from leaf nodes towards DAG roots, e.g., following the orientation of the edges within the DAG. Conversely, “downward” or “down” paths are routes that lead in the direction from DAG roots towards leaf nodes, e.g., generally going in the opposite direction to the upward messages within the DAG.

Generally, a DAG discovery request (e.g., DIO) message is transmitted from the root device(s) of the DAG downward toward the leaves, informing each successive receiving device how to reach the root device (that is, from where the request is received is generally the direction of the root). Accordingly, a DAG is created in the upward direction toward the root device. The DAG discovery reply (e.g., DAO) may then be returned from the leaves to the root device(s) (unless unnecessary, such as for UP flows only), informing each successive receiving device in the other direction how to reach the leaves for downward routes. Nodes that are capable of maintaining routing state may aggregate routes from DAO messages that they receive before transmitting a DAO message. Nodes that are not capable of maintaining routing state, however, may attach a next-hop parent address. The DAO message is then sent directly to the DODAG root that can in turn build the topology and locally compute downward routes to all nodes in the DODAG. Such nodes are then reachable using source routing techniques over regions of the DAG that are incapable of storing downward routing state.

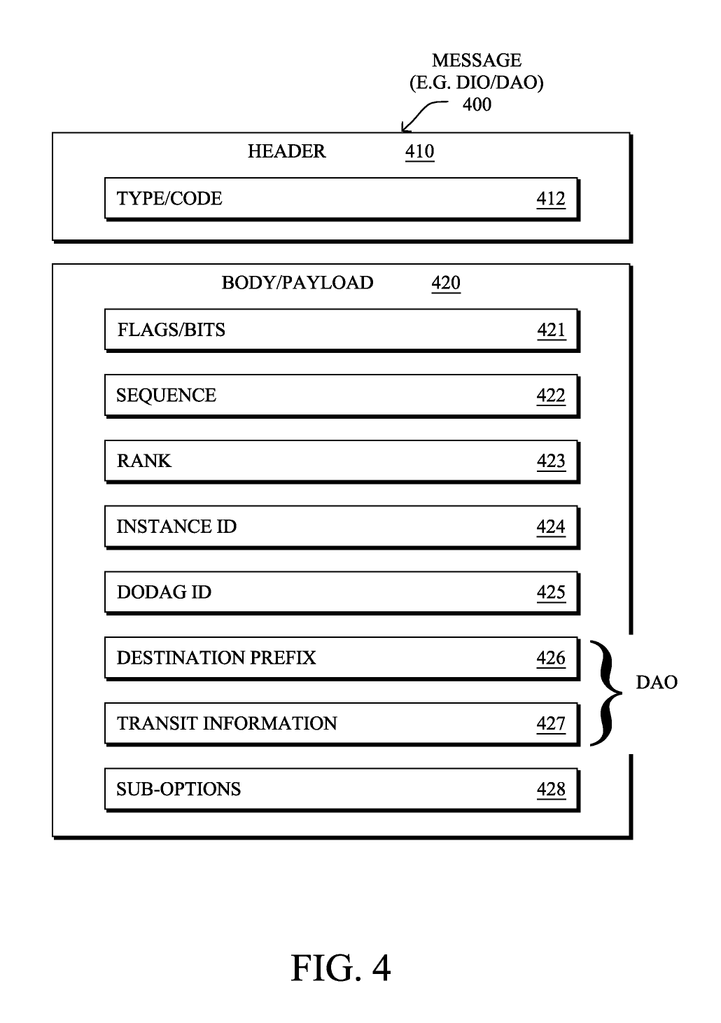

FIG. 4 illustrates an example simplified control message format 400 that may be used for discovery and route dissemination when building a DAG, e.g., as a DIO or DAO. Message 400 illustratively comprises a header 410 with one or more fields 412 that identify the type of message (e.g., a RPL control message), and a specific code indicating the specific type of message, e.g., a DIO or a DAO (or a DAG Information Solicitation). Within the body/payload 420 of the message may be a plurality of fields used to relay the pertinent information. In particular, the fields may comprise various flags/bits 421, a sequence number 422, a rank value 423, an instance ID 424, a DODAG ID 425, and other fields, each as may be appreciated in more detail by those skilled in the art. Further, for DAO messages, additional fields for destination prefixes 426 and a transit information field 427 may also be included, among others (e.g., DAO_Sequence used for ACKs, etc.). For either DIOs or DAOs, one or more additional sub-option fields 428 may be used to supply additional or custom information within the message 400. For instance, an objective code point (OCP) sub-option field may be used within a DIO to carry codes specifying a particular objective function (OF) to be used for building the associated DAG. Alternatively, sub-option fields 428 may be used to carry other certain information within a message 400, such as indications, requests, capabilities, lists, etc., as may be described herein, e.g., in one or more type-length-value (TLV) fields.

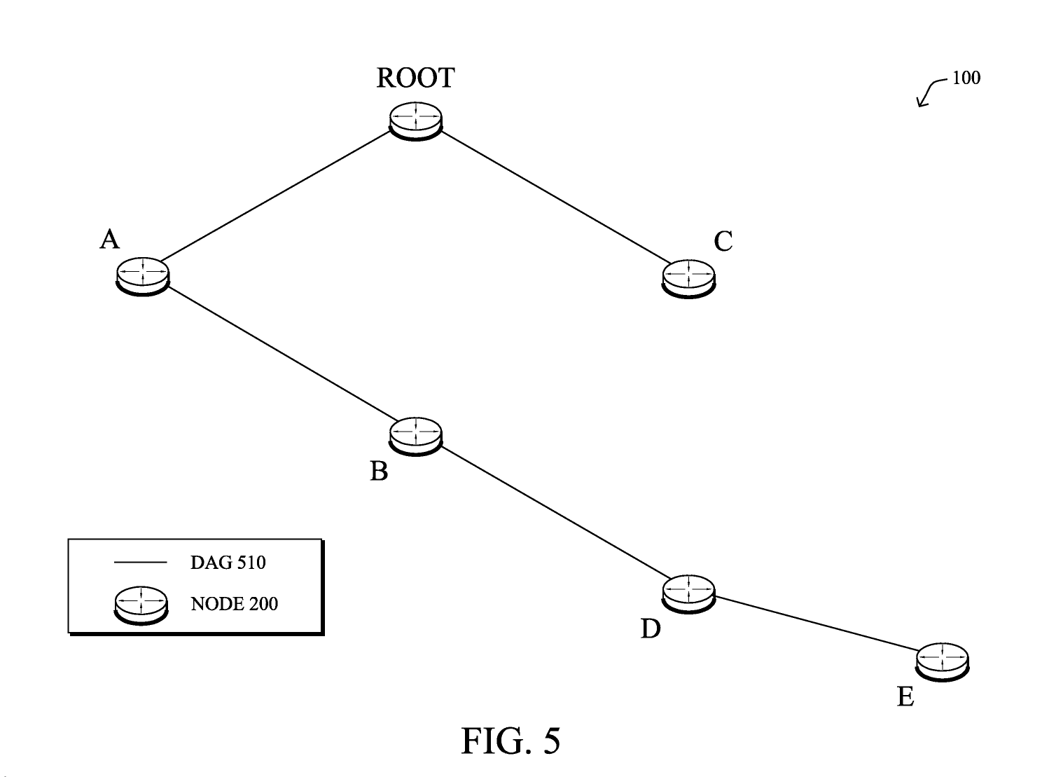

FIG. 5 illustrates an example simplified DAG 510 that may be created, e.g., through the techniques described above (by DAG process 246), within network 100 of FIG. 1. For instance, certain links 105 may be selected for each node to communicate with a particular parent (and thus, in the reverse, to communicate with a child, if one exists). These selected links form the DAG 510 (shown as straight lines), which extends from the root node toward one or more leaf nodes (nodes without children). Traffic/packets 140 (shown in FIG. 1) may then traverse the DAG 510 in either the upward direction toward the root or downward toward the leaf nodes.

Frequency Hopping

Frequency hopping, also referred to as “frequency-hopping spread spectrum” (FHSS) is a method of transmitting radio signals by rapidly switching a carrier among numerous frequency channels, e.g., using a pseudorandom sequence known to both transmitter and receiver. For example, frequency hopping may be utilized as a multiple access method in the frequency-hopping code division multiple access (FH-CDMA) scheme. Generally, as may be appreciated by those skilled in the art, transmission using frequency hopping is different from a fixed-frequency transmission in that frequency-hopped transmissions are resistant to interference and are difficult to intercept. It also allows for increasing the overall network capacity of the RF network. Accordingly, frequency-hopping transmission is a useful technique for many applications, such as sensor networks, LLNs, military applications, etc.

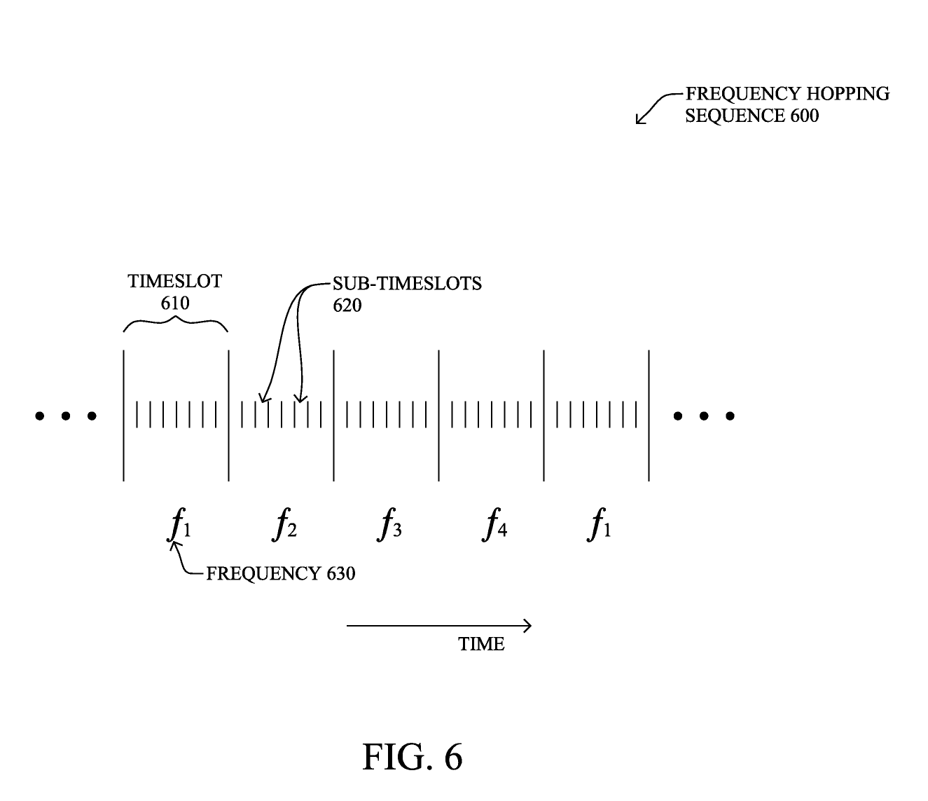

In particular, as noted above and as shown in FIG. 6, in frequency hopping wireless networks, time frames are divided within a frequency hopping sequence 600 into regular timeslots 610, each one operating on a different frequency 630 (e.g.,f₁-f₄). A reference clock may be provided for the time frames for an entire network (e.g., mesh/cell), and a MAC layer 212 of each node 200 divides time into timeslots that are aligned with the timeslot boundary of its neighbor (e.g., a parent node). Also, each timeslot 610 may be further divided into sub-timeslots 620. Illustratively, the MAC layer 212 is in charge of scheduling the timeslot in which a packet is sent, the main objective of which being randomization of the transmission time in order to avoid collisions with neighbors' packets. Note that the MAC layer 212 must not only schedule the data messages coming from upper layers of a protocol stack, but it also must schedule its own packets (e.g., acknowledgements, requests, beacons, etc.).

When a packet 300 is sent in a timeslot, depending on its size (length), the transmission may start at a different sub-timeslots, and the transmission of acknowledgements (ACKs) will be done as soon as possible after the reception of the message that triggered them (i.e., within the timeslot of the reception). That is, in order to minimize collisions between packets, the MAC layer randomizes the sub-timeslot in which it starts sending each packet. Given the fact that the length of data packets may vary according to the size of their payload, the randomization parameters need to be adjusted accordingly. For example, when the system uses eight (8) sub-timeslots, and the packet is of a size smaller than 1 sub-timeslot, the MAC layer may start transmission in sub-timeslot (STS) 0, 1, 2, 3, 4, 5, or 6, reserving sub-timeslot 7 for the acknowledgement message from the receiving node. However, as the size of the payload increases, the randomization window is decreased. For instance, when the packet size occupies 3 sub-timeslots, the MAC layer may start transmission of this packet in timeslots 0, 1, 2, 3, or 4, and not 5 (to leave room for the acknowledgement) or 6-7 (since the packet would not fit within the timeslot). In other words, as the size of a packet increases, the randomization window decreases, consequently impairing the ability of the system to alleviate packet collision.

In addition, as noted above, the length of messages/information transmitted may vary such that while most messages are short (e.g., shorter than a timeslot), when a large message needs to be sent either to or from a wireless node, the Network or MAC layer fragments the long message into smaller packets and transmits each fragment as a packet over the air. Since wireless mesh networks are prone to collisions, it is more difficult and inefficient to transmit large messages, as each of the packet fragments have a chance of collision, loss, etc. Further, since the start of packet transmissions are randomized as noted above, this delay may further reduce the efficiency of air time utilization and may delay the delivery of the overall message.

On-Demand Orthogonal Frequency Hopping

The techniques described herein allow two communicating nodes (sender and receiver) to synchronously move to another (orthogonal) frequency hopping sequence to transmit large messages. In particular, a communication system according to one or more embodiments described in greater detail below improves network efficiency and reduces the delivery delay of large messages, and greatly reduces the number collisions when a large message needs to be transmitted by moving the communicating peers to a dedicated hopping sequence that is orthogonal to hopping sequences of neighboring nodes (including hidden neighbors). In addition, while in an orthogonal frequency hopping sequence, the MAC layer may be adjusted to start transmitting at the beginning of timeslots, and to maximize the length of the packets in order to occupy the full length of a timeslot (and/or to utilize the whole timeslot with multiple packets).

Notably, the decision whether a transmitting node (sender) will request an enhanced association with a receiving node (receiver) to move to an orthogonal frequency hopping sequence can be based on configuration or policies within the network. For instance, various factors in addition to message size may be used to determine whether to move to another frequency hopping sequence, such as message priority, general network congestion/density, etc.

Illustratively, the techniques described herein may be performed by hardware, software, and/or firmware, such as in accordance with a network interface module (e.g., MAC layer module 212), which may contain computer executable instructions executed by a processor (e.g., processor 220 or an independent processor within the network interface 210) to perform functions relating to the novel techniques described herein, such as, e.g., as part of a frequency hopping communication protocol. For example, the techniques herein may be treated as extensions to conventional wireless communication protocols, such as the 802.11 protocol, WiFi, etc., and as such, would be processed by similar components understood in the art that execute such protocols, accordingly.

Operationally, from the perspective of a transmitting node or “sender” (e.g., node B), the MAC layer 212 may obtain a message to transmit, such as a message from higher layers (e.g., application layers, routing layers, etc.) or else messages/packets that are generated by the MAC layer itself, as noted above. The sender then classifies the message as a “large message” based on whether it needs to be fragmented into a plurality of packets for transmission to a receiver. Alternatively, the sender may classify a “large message” as a plurality of messages/packets to be transmitted in series (i.e., without need for fragmenting) that would span multiple frequency hopping timeslots 610.

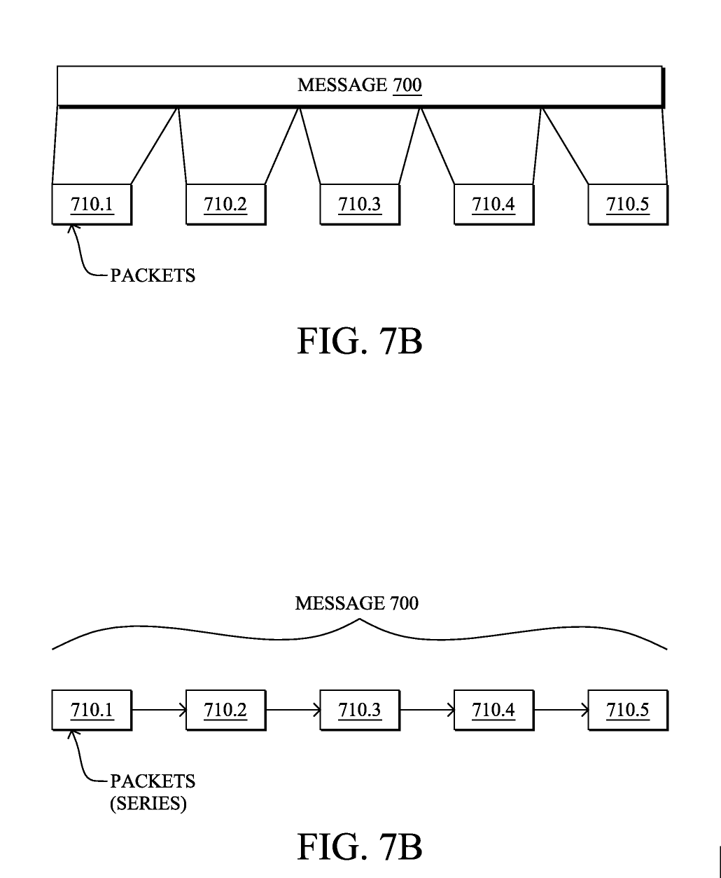

FIGS. 7A and 7B illustrate two example “large messages” 700 that may be classified by the sender. For instance, FIG. 7A shows how a single large message 700 may need to be fragmented into a plurality of smaller packets 710 for transmission. Note that when using IPv6, which does not allow intermediate routers to fragment messages, such messages can be fragmented by lower layers and the API between the MAC and IP layer can signal that a frame carries a fragmented packet. It should also be noted that because of the high Bit Error Rate (BER) of lossy links, it is not rare to fragment large messages/packets 700 into a set of smaller fragments 710. In particular, as will be appreciated by those skilled in the art, the loss of one fragment leads to the loss of the entire packet if the link layer does not provide fragment recovery.

Also, FIG. 7B shows how a plurality of smaller packets 710 in series (710.1, 710.2, etc., “710” generally herein) may be related enough (e.g., pre-fragmented by higher layers, part of an urgent multi-packet message, etc.) to consider a “large message” 700. In other words, if a sender node identifies that it has multiple packets (originating from different messages) which are destined to (or forwarded via) the same receiver node, such packets may be classified as a large message.

Once a large message 700 is identified/classified, then the sender indicates to the intended receiver that the message to be transmitted is a large message. In particular, this indication when received by the receiver requests the use of an orthogonal frequency hopping sequence between the sender and receiver for the duration of the large message transmission.

In one embodiment, the indication takes the form of one or more flags (bits) set within the plurality of packets 710. This marking of the packets can take place in the layer 2 header (310) of the data packets 300/710 or the packet itself (payload 320) when allowed. The marking of packets as belonging to a very large message 700 thus serves as an implicit indication to the receiver that the sender requests that the receiver move to a private orthogonal frequency hopping sequence. That is, from the receiver's perspective (e.g., node A), when a header 310 of a packet 300 is received, the receiver (e.g., its MAC layer 212) analyzes the packet for an indication to determine whether the receiving node is to proceed to an orthogonal frequency hopping sequence to receive additional packets of the large message 700.

Note that in this embodiment, the sender may first determine whether an intended receiver supports orthogonal frequency hopping sequence operation, and then only if so may mark the packets 710 of a large message 700 as described above. Illustratively, the ability of neighboring nodes to agree on the support of orthogonal sequences may be exchanged through various capability advertisement mechanisms depending upon the underlying protocols used. For instance, according to one or more specific embodiments herein, the wireless nodes 200 of the network 100 may be participants in a DAG topology 510 as noted above. To this end, a new TLV may be defined that is carried within the DAG metric container itself (carried in the DIO message 400) that specifies the ability for a node to support orthogonal frequency hopping. Note that the TLV may also be added to the DAO message traveling upward for communication in the downward direction, so the parent can be aware of whether its child nodes can also support the extended timeslots as well. As an example, the ability the support the proposed extended mode may be advertised in a node capability object carried within a node state and attribute (NSA) object of message 400.

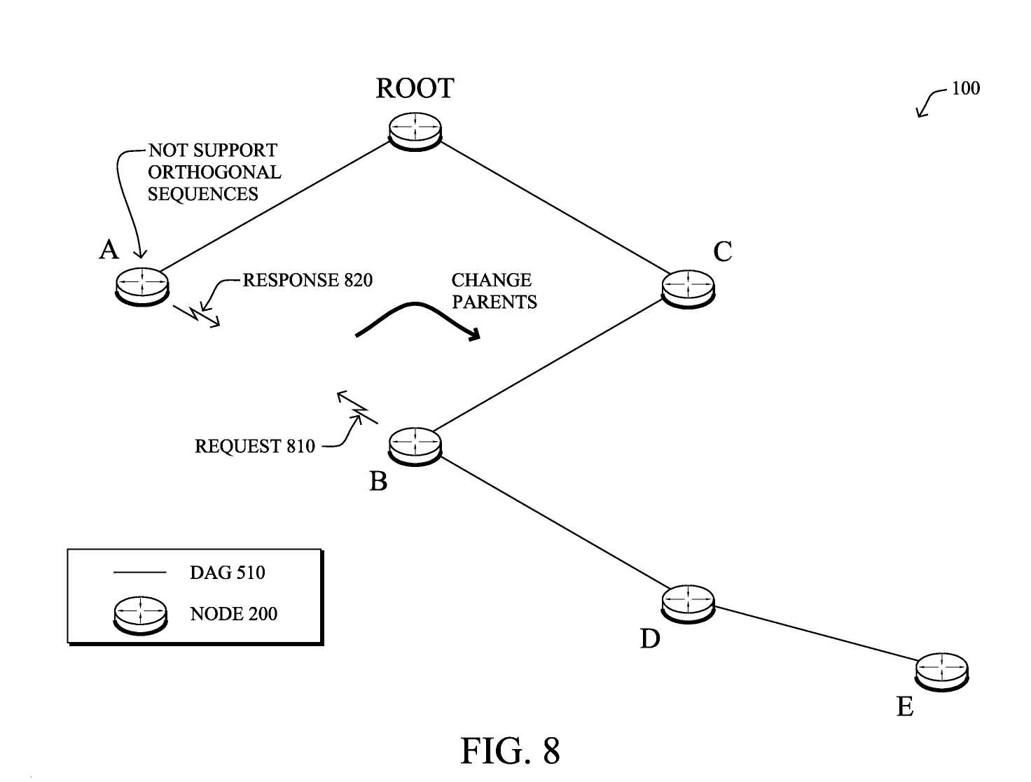

Note further that such capability can be used by the potential neighbors during the parent selection process within a DAG 510, e.g., should a node determine based on historical observation that it is likely to carry large packets. In particular, as illustrated in FIG. 8, when a child (e.g., node B) decides to select a preferred parent, it may send a request 810 to this node (e.g., node A) specifying the mode of operation (use of orthogonal frequency hopping sequences). If the parent agrees to support that mode, no further message is required (other than an ACK), though one may be provided (response 820). If the node does not support the feature, then a response 820 may be sent back to the child indicating as such. The child may consider this response (rejection) when selecting parents, and consequently may select another preferred parent (e.g., node C as shown); such a choice to select another parent may be driven by the historical knowledge that larger packets are frequently forwarded by the node. Also, when a parent node (e.g., node A) determines that it has a child node (e.g., node B), the parent node may also send a request to determine whether the child supports orthogonal frequency hopping (if not supported, the parent may, in certain embodiments, request that the child node choose another parent).

It should be pointed out that requests 810 and responses 820 are not limited to use during parent selection within a DAG. For example, in one or more embodiments, the requests and responses may simply be exchanged during neighbor capability discovery before any large messages need to be transmitted.

Further, in one embodiment, the indication that the message to be transmitted is a large message takes the form of a request 810, such as through the sending of an orthogonal rendezvous request message 810 from the sender to the receiver prior to transmitting the large message. This orthogonal rendezvous request message 810 (or an Orthogonal Rendezvous Hopping Sequence (ORHS) message) may be illustratively carried within an IPv6 extended header or the MAC frame, and is utilized by the sender to alert the receiver about the fact that it needs to send multiple packets on an orthogonal frequency hopping sequence. When the receiver receives the request 810, it determines whether it can comply with the request, i.e., that it is willing to engage with the sender in an enhanced association. If so, the receiver acknowledges the receipt of the request 810 and indicates its acceptance of the request for the enhanced engagement, i.e., the receiver returns an acknowledgment that the receiver can comply with the request.

The actual orthogonal frequency hopping sequence to be used during the enhanced engagement may be determined in a variety of manners herein, though each results in a sequence that is orthogonal to a shared frequency hopping sequence 600 of the wireless network 100. For instance, in one embodiment in a system where all of the nodes share the same frequency hopping sequence, the orthogonal frequency hopping sequence can be derived by utilizing the shared hopping sequence 600 with a random shift. For example, assuming the shared sequence 600 of FIG. 6 above (f₁, f₂, f₃, f₄), a shift of 2 might result in the orthogonal sequence at that time being: f₃, f₄, f₁, f₂. In one or more embodiments, an orthogonal frequency hopping sequence may be shared by the nodes of the network and advertised in advance, such that there is a general shared sequence 600, and then a separate sequence that is orthogonal to that general shared sequence that may be used during enhanced engagements.

In accordance with another example embodiment, the orthogonal frequency hopping sequence can be either proposed by the sender, receiver, or via a system configuration. In particular, the sender and receiver may negotiate the orthogonal frequency hopping sequence to use during an enhanced engagement. This negotiation may occur a priori (i.e., in advance of the sender classifying a message as a large message), or during an on-demand explicit request/response exchange noted above (e.g., within request 810 and/or response 820). In one embodiment, when the orthogonal frequency hopping sequence is exchanged between the sender and receiver, such a negotiated sequence may be advertised to neighbor nodes of at least the sender/receiver (and possibly to hidden neighbors, i.e., two hops away), such that neighbors in the same vicinity could pre-compute different sequences, thus avoiding collisions even more.

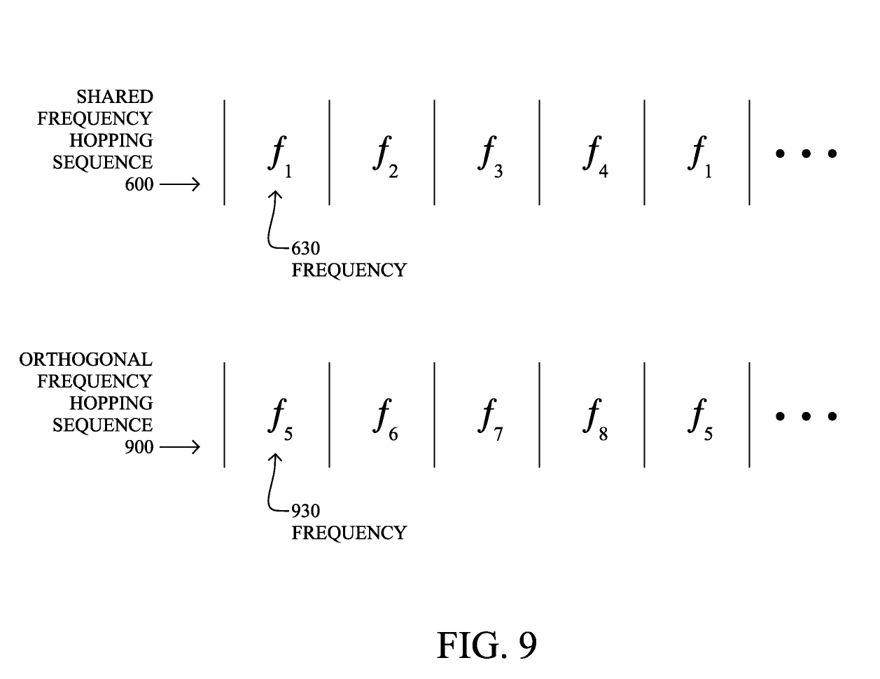

FIG. 9 illustrates an example orthogonal frequency hopping sequence 900, in comparison to the shared frequency hopping sequence 600 of FIG. 6 above. As an illustrative example, an entirely different set of frequencies occupy timeslots 930 of orthogonal sequence 900 (e.g., f₅, f₆, f₇, f₈), though as noted above, the same frequencies as the shared sequence 600 may be used in different (and orthogonal) orders, and as such, the notation of frequencies f₅, f₆, f₇, f₈ may simply imply the same set of frequencies as the shared sequence 600, but in a different order (e.g., where f₅, f₆, f₇, f₈ is equivalent to f₃, f₄, f₁, f₂ as mentioned above. Note also that the sequences 600 and 900 are simplified examples, and that frequency hopping sequences (e.g., superframes) generally comprise far greater frequencies before returning to the first frequency in the sequence.

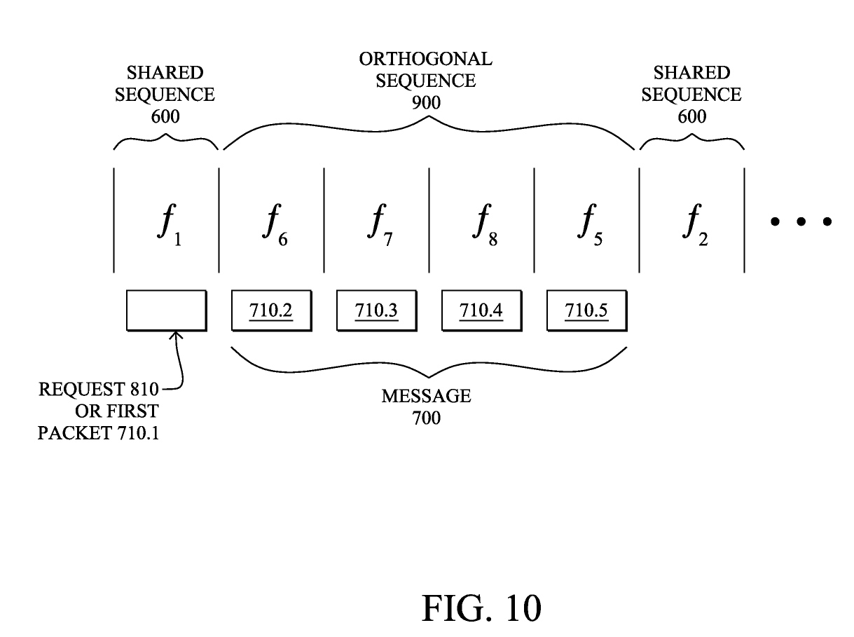

FIG. 10 illustrates the transmission of the large message 700 from the sender to the receiver on the orthogonal frequency hopping sequence 900, which is received by the receiver also listening on the orthogonal frequency hopping sequence. In particular, as noted above, a first packet 710 in a first timeslot (corresponding to f₁) may be transmitted from any sub-timeslot and may either be a first packet fragment 710 with an embedded indication of a large message 700, or else may be an actual orthogonal rendezvous request 810. As a result, assuming the receiver can comply, both the sender and receiver move to the orthogonal frequency hopping sequence 900 for the duration of the message 700, i.e., returning to the shared frequency hopping sequence 600 upon completion of the large message transmission (e.g., in a next timeslot, or within a timeslot at a particular sub-timeslot if so configured). For instance, while other nodes in the network may remain on the shared sequence (or else their own orthogonal sequences) the entire time, i.e.,f₁, f₂, f₃, f₄, f₁, f₂, the sender and receiver follow the semi-orthogonal sequence: f₁, f₆, f₇, f₈, f₅, f₂ as shown (e.g., when using the illustratively shifted shared frequencies above as: f₁, f₄, f₁, f₂, f₃, f₂). Note that “semi-orthogonal” implies that for portions of the sequence there is overlap with the shared sequence 600, such as to initiate/request the message transmission in a first timeslot, as well as timeslots after the orthogonal transmission is completed (or, as discussed below, to temporarily “pause” the orthogonality).

Since the sender and receiver utilize a dedicated (orthogonal) frequency hopping sequence, the transmission between these two nodes is generally immune to collisions with packets to/from their neighbors. More specifically, the transmission of the large message 700 by the sender is not adversely affecting its neighbors' communication and additionally the receiver can receive the packets 710 without experiencing packet collision with packets from its neighbors. Once the sender and receiver start utilizing the orthogonal hopping sequence 900, the sender may initiate transmission of one or more of the plurality of packets during a first sub-timeslot, i.e., with an offset of 0 with respect to the beginning of the timeslot (as randomization is no longer required). Additionally, the sender may also start sending longer packets in the timeslots which have been reserved for this communication (e.g., the entire useful length of a timeslot) or alternatively may send multiple back-to-back packets within the same timeslot.

is In accordance with yet another aspect of the techniques herein, when neighboring nodes observe that the sender and receiver (e.g., nodes B and A) agree to establish an orthogonal communication channel, the neighbors may store messages destined to nodes B and A during the orthogonal timeslots. By not sending messages to nodes B and A during the time when these nodes are not tuned to receiving them, collisions with packets from other nodes is alleviated thus improving network efficiency. In accordance with yet another related embodiment, if the children or parents of nodes A and B attempt to send to them a message on the global hopping frequency sequence (on which they are not listening), the message would not be acknowledged and the sender may select an alternate path.

At the same time, however, since no other packets (from other neighbors) may be received by the sender or receiver during their “private” orthogonal communication, urgent messages may be missed or delayed (e.g., including the optionally stored messages at the neighbors mentioned above). In order to facilitate other message flows to or through nodes B and A, the system in accordance with one or more embodiments herein may reserve specific dedicated timeslots wherein senders and receivers periodically participate in (visit) the global shared frequency hopping sequence 600, thus facilitating communication with other nodes. The specifics of what percentage of their time the sender and receiver should use the private orthogonal hopping sequence 900 and how much time they should utilize the shared hopping sequence 600 can be predetermined via configuration or dynamically decided based on the priority of the large message 700 and its length (or as indicated above, by the number of packets 710 which need to be forwarded to/via the receiver).

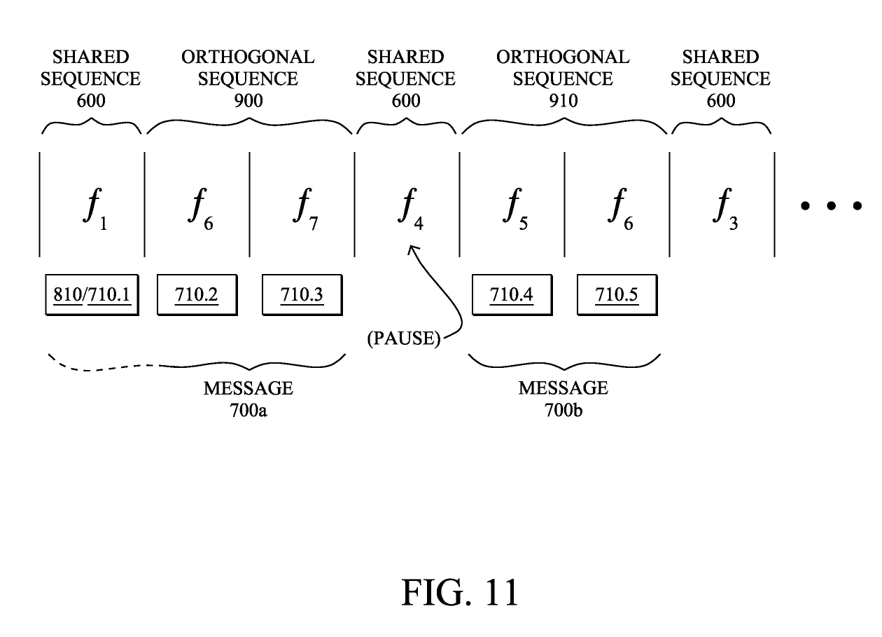

For example, FIG. 11 shows an illustrative “pause” in the large message transmission, where the sender pauses the transmission of the large message after segment 700a, and returns to the shared frequency hopping sequence 600 for a particular duration (e.g., one timeslot as shown, f₄). This particular duration and timeslot may be pre-configured, such as all senders/receivers returning for f₄ regardless of where that pause takes place, or else returning after two timeslots at the orthogonal sequence 900, etc. After the pause (e.g., after receiving any pending messages or upon expiration of the particular duration), the sender and receiver may each return to the orthogonal frequency hopping sequence 900 and resuming the transmission/reception of the large message 700 (segment 700b).

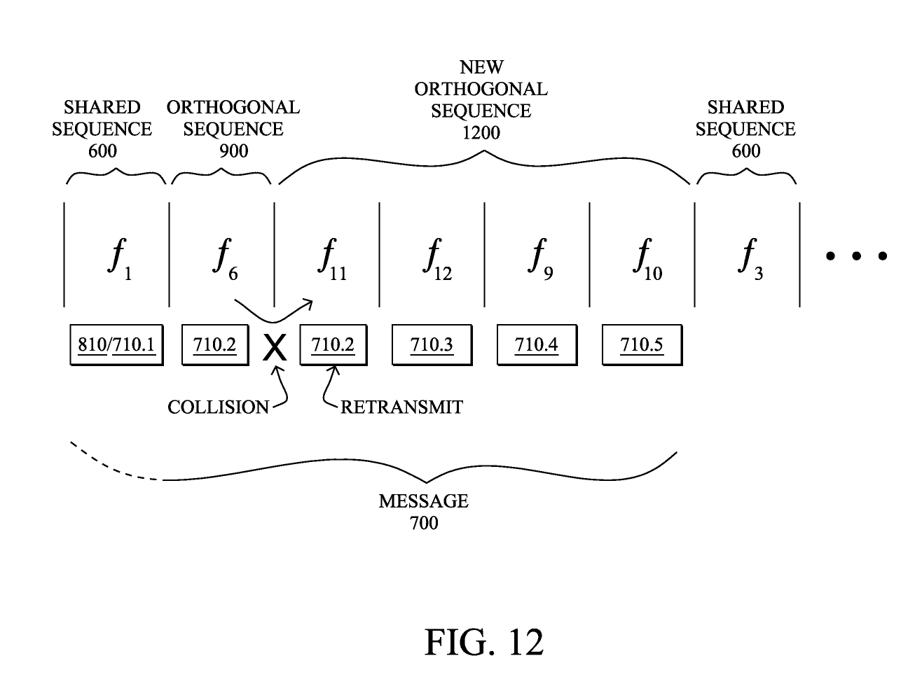

There may be circumstances in which two pairs of peer nodes that are in proximity to each other happen to select the same orthogonal hopping sequence, and as such may encounter a large number of packet collisions. In the event this is detected, as shown in FIG. 12, the receiving node may send a NACK to the sender with a suggestion for a new orthogonal hopping sequence that is orthogonal to the original orthogonal frequency hopping sequence 900 and the shared frequency hopping sequence 600. Once the new orthogonal hopping sequence 1200 is selected, e.g., f₉, f₁₀, f₁₁, f₁₂ (shown as f₁₁, f₁₂, f₉, f₁₀ to coincide with the shared sequence 600, as an example), then the originally collided packet 710 may be retransmitted, and the remainder of the message 700 may be transmitted on the new sequence 1200.

In one particular embodiment, if the collision occurs for a particular sender/receiver pair in the first orthogonal timeslot (e.g., as shown in FIG. 12), then it may be assumed that the transmission has “stepped on” another orthogonal transmission already in progress, and as such, that particular pair may move to another orthogonal sequence. In this manner, if a second sender/receiver pair experiences collisions in a later timeslot during their transmission, then this second pair may simply reattempt to transmit the collided packets under the assumption that the first particular pair will have moved on. (If not, the second pair may also move in a subsequent timeslot if collisions are still present.)

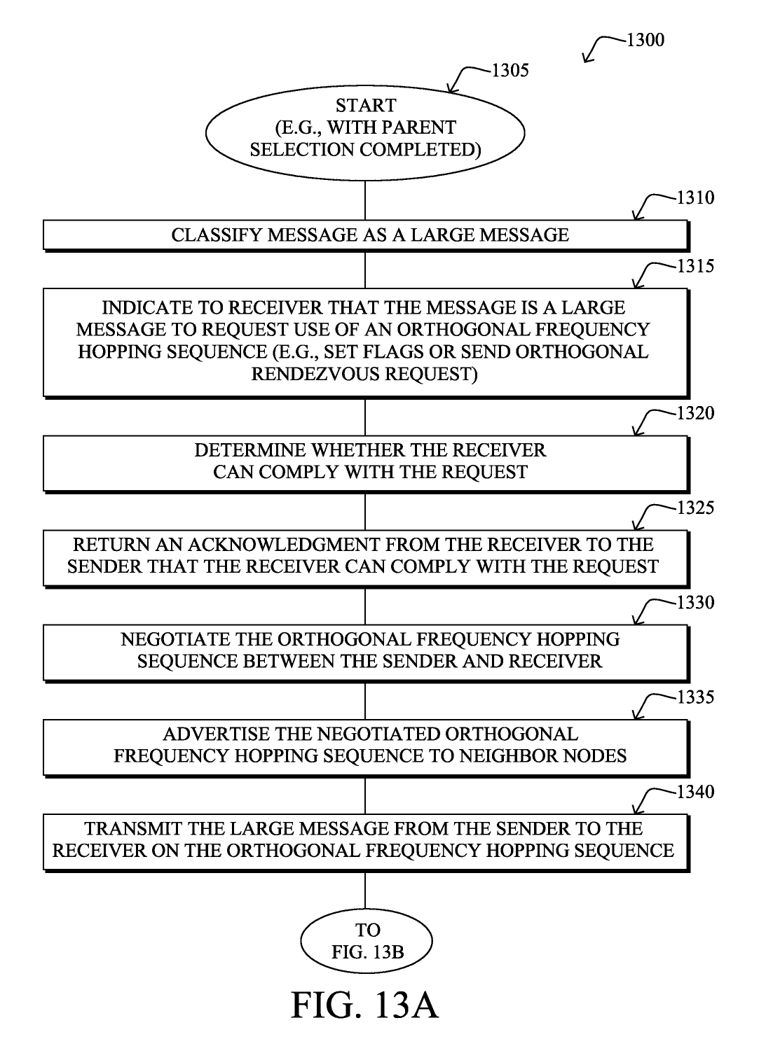

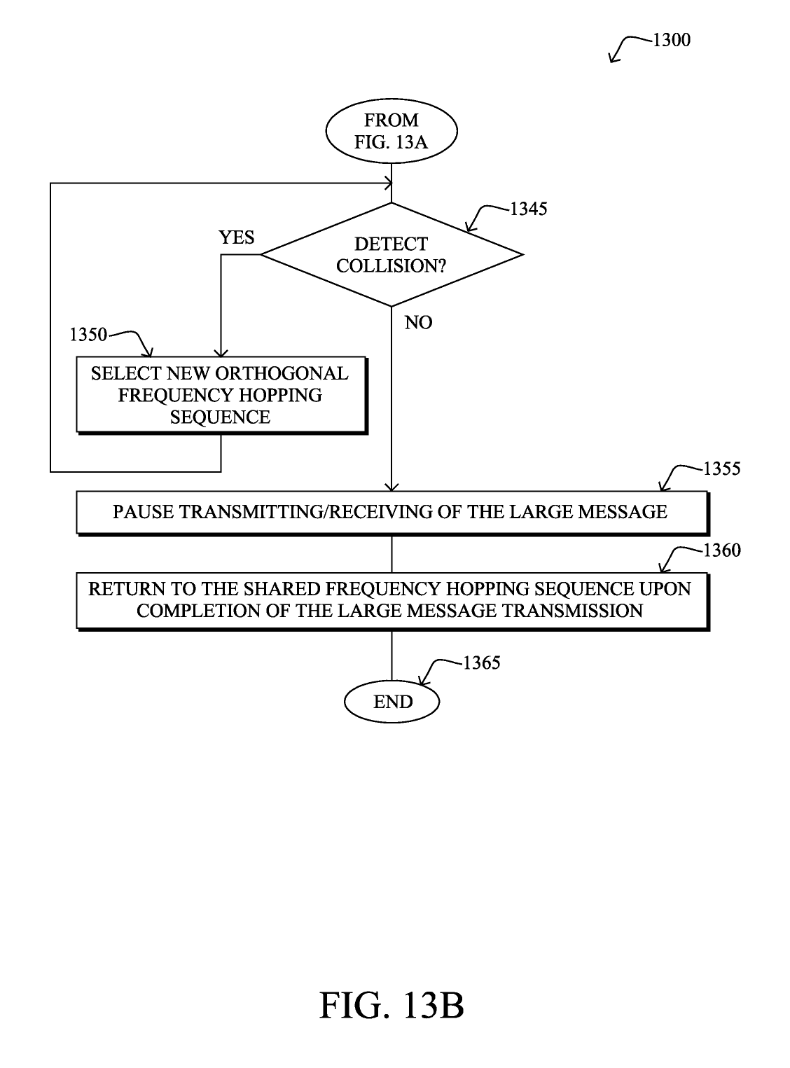

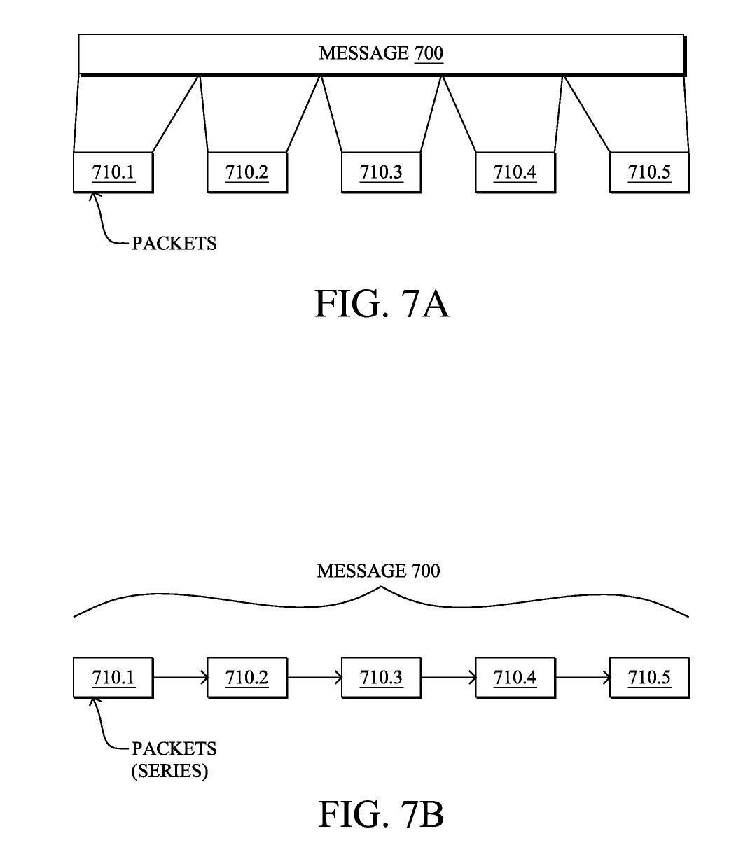

FIGS. 13A-B illustrate an example simplified procedure for efficient transmission of large messages in wireless networks through the use of on-demand orthogonal frequency hopping sequences in accordance with one or more embodiments described herein. The procedure 1300 starts at step 1305 (e.g., with DAG parent selection completed in corresponding embodiments), and continues to step 1310, where a sender (e.g., MAC layer 212 of node B) classifies a message as a large message 700 based on factors discussed above. As such, the sender may then indicate in step 1315 to a receiver (e.g., node A) that the message is a large message to request use of an orthogonal frequency hopping sequence 900 for the message. For instance, as described above, the sender may simply set various flags within the packet headers 310 under the assumption or predetermined knowledge that the receiver will participate in the orthogonal rendezvous, or else may send an orthogonal rendezvous request 810 to the receiver to explicitly request the orthogonal rendezvous.

In either situation, though more particularly in response to the explicit request, the receiver may determine whether it can comply with the request in step 1320, and if need be (e.g., for explicit requests), may return an acknowledgment (response 820) to the sender indicating as such in step 1325. Note that in step 1330 the sender and receiver may optionally negotiate the orthogonal frequency hopping sequence, which may occur either during an on-demand explicit request/response exchange, a priori between the two devices, or a priori for the network 100 as a whole, as noted above. In either of the first two example negotiations, in step 1335 the sender and/or receiver may also optionally advertise the negotiated orthogonal frequency hopping sequence to neighbor nodes, accordingly.

In step 1340 the sender transmits the large message to the receiver on the orthogonal frequency hopping sequence 900, and the procedure continues to FIG. 13B where if a collision is detected in step 1345 during the large message transmission, illustratively in the first frame of the orthogonal frequency hopping sequence as noted above, then in step 1350 the sender (and receiver) may select a new orthogonal frequency hopping sequence 1200 under the assumption that another pair of nodes is already using the orthogonal frequency hopping sequence 900. Also, in certain embodiments described above, in step 1355 the transmitting/receiving of the large message may be paused, e.g., in order to allow for periods of time where the sender and receiver are able to listen to the other nodes of the network 100 in case there are any pending (e.g., urgent) messages to be sent to the sender or receiver.

In step 1360, the sender and receiver return to the shared frequency hopping sequence 600 upon completion of the large message transmission, and the procedure 1300 ends in step 1365. It should be noted that certain steps within procedure 1300 above may be optional, and that the steps shown in FIGS. 13A-B are merely an example for illustration, and certain steps may be included or excluded as desired.

The novel techniques described herein, therefore, provide for efficient transmission of large messages in wireless networks through the use of on-demand orthogonal frequency hopping sequences. In particular, as described above, peer nodes (sender/receiver) establish private communication channels which greatly minimize packet collisions, and allow for the peer nodes to utilize all of the available time / bandwidth within timeslots, thus increasing network (resource) utilization and reducing message delay. Further, given the fact that the two peer nodes move to a dedicated orthogonal channel, interferences from other weaker neighbors (including hidden neighbors) are greatly reduced. This potentially lowers the noise level allowing for more reliable packet exchange or alternatively allowing the transmitting node to reduce its power. Note that the techniques herein provide a beneficial alternative to requesting that all nodes in the mesh stop sending messages in order to free up air time for large / urgent messages, which has the drawback that many nodes which otherwise would not have interfered with transmission of a large message are requested to stop transmitting, thus greatly reducing the overall available bandwidth of the LLN.

While there have been shown and described illustrative embodiments that provide for efficient transmission of large messages in wireless networks through the use of on-demand orthogonal frequency hopping sequences, it is to be understood that various other adaptations and modifications may be made within the spirit and scope of the embodiments herein. For example, the embodiments have been shown and described herein with relation to wireless networks, such as LLNs. However, the embodiments in their broader sense are not as limited, and may, in fact, be used with other types of networks and/or protocols where only certain nodes within the network communicate wirelessly. Also, while the description above relates to packets and packet headers, the techniques may be equally applicable to non-packetized transmissions where there is reason to maintain an orthogonal transmission for a long message (e.g., a long analog transmission signal on a shared network).

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software being stored on a tangible (non-transitory) computer-readable medium (e.g., disks/CDs/etc.) having program instructions executing on a computer, hardware, firmware, or a combination thereof. Accordingly this description is to be taken only by way of example and not to otherwise limit the scope of the embodiments herein. Therefore, it is the object of the appended claims to cover all such variations and modifications as come within the true spirit and scope of the embodiments herein.

What is claimed is:

1. A method, comprising:
classifying a message at a sender in a frequency hopping wireless network as a large message to be fragmented into a plurality of packets for transmission to a receiver;
indicating to the receiver that the message is a large message to request use of an orthogonal frequency hopping sequence between the sender and receiver for the duration of the large message transmission, the orthogonal frequency hopping sequence orthogonal to a shared frequency hopping sequence of the wireless network;
transmitting the large message from the sender to the receiver on the orthogonal frequency hopping sequence; and
returning to the shared frequency hopping sequence upon completion of the large message transmission.

2. The method as in claim 1, wherein the message is selected from either a single large message or a plurality of messages to be transmitted in series.

3. The method as in claim 1, wherein indicating comprises:
setting a flag within the plurality of packets.

4. The method as in claim 1, wherein indicating comprises:
sending an orthogonal rendezvous request message from the sender to the receiver prior to transmitting the large message.

5. The method as in claim 1, further comprising:
pausing the transmitting of the large message;
returning to the shared frequency hopping sequence for a particular duration;
returning to the orthogonal frequency hopping sequence upon expiration of the particular duration; and
resuming the transmitting of the large message.

6. The method as in claim 1, further comprising:
negotiating the orthogonal frequency hopping sequence between the sender and receiver.

7. The method as in claim 6, further comprising:
negotiating the orthogonal frequency hopping sequence between the sender and receiver in advance of classifying the message as a large message.

8. The method as in claim 6, further comprising:
advertising the negotiated orthogonal frequency hopping sequence to neighbor nodes of at least the sender.

9. The method as in claim 1, further comprising:
selecting the receiver as a parent node for the sender in a directed acyclic graph (DAG) based on an ability of the parent node to use the orthogonal frequency hopping sequence.

10. The method as in claim 1, further comprising:
detecting a collision of the transmitting on a first orthogonal frequency hopping sequence;
in response, selecting a second orthogonal frequency hopping sequence that is orthogonal to the first orthogonal frequency hopping sequence and shared frequency hopping sequence; and
transmitting the large message from the sender to the receiver on the second orthogonal frequency hopping sequence.

11. The method as in claim 1, further comprising:
initiating transmission of one or more of the plurality of packets during a first sub-timeslot of timeslots of the orthogonal frequency hopping sequence.

12. An apparatus, comprising:
one or more wireless network interfaces configured to communicate in a frequency hopping wireless network;
a processor coupled to the wireless network interfaces and adapted to execute one or more processes; and
a network interface module coupled to the processor and the wireless network interfaces, the network interface module configured to:
classify a message as a large message to be fragmented into a plurality of packets for transmission to a receiver;
indicate to the receiver that the message is a large message to request use of an orthogonal frequency hopping sequence with the receiver for the duration of the large message transmission, the orthogonal frequency hopping sequence orthogonal to a shared frequency hopping sequence of the wireless network;
transmit the large message to the receiver on the orthogonal frequency hopping sequence; and
return to the shared frequency hopping sequence upon completion of the large message transmission.

13. The apparatus as in claim 12, wherein the network interface module is further configured to indicate to the receiver that the message is a large message by setting a flag within the plurality of packets.

14. The apparatus as in claim 12, wherein the network interface module is further configured to indicate to the receiver that the message is a large message by sending an orthogonal rendezvous request message to the receiver prior to transmitting the large message.

15. A tangible, non-transitory, computer-readable media having software encoded thereon, the software when executed by a processor on a device in a frequency hopping wireless network operable to:
classify a message as a large message to be fragmented into a plurality of packets for transmission to a receiver;
indicate to the receiver that the message is a large message to request use of an orthogonal frequency hopping sequence with the receiver for the duration of the large message transmission, the orthogonal frequency hopping sequence orthogonal to a shared frequency hopping sequence of the wireless network;
transmit the large message to the receiver on the orthogonal frequency hopping sequence; and
return to the shared frequency hopping sequence upon completion of the large message transmission.

16. A method, comprising:
receiving, at a receiver in a frequency hopping wireless network, an indication that a message from a sender is a large message, the indication to request use of an orthogonal frequency hopping sequence between the sender and receiver for the duration of the large message transmission, the orthogonal frequency hopping sequence orthogonal to a shared frequency hopping sequence of the wireless network;
receiving the large message at the receiver from the sender on the orthogonal frequency hopping sequence; and
returning to the shared frequency hopping sequence upon completion of the large message transmission.

17. The method as in claim 16, wherein the indication comprises a flag set within a plurality of packet fragments of the large message.

18. The method as in claim 16, wherein the indication comprises an orthogonal rendezvous request message from the sender to the receiver prior to the sender transmitting the large message, the method further comprising:
determining that the receiver can comply with the request; and
returning an acknowledgment from the receiver to the sender that the receiver can comply with the request.

19. The method as in claim 16, further comprising:
pausing the receiving of the large message;
returning to the shared frequency hopping sequence for a particular duration;
returning to the orthogonal frequency hopping sequence upon expiration of the particular duration; and
resuming the receiving of the large message.

20. The method as in claim 16, further comprising:
negotiating the orthogonal frequency hopping sequence between the sender and receiver.

21. The method as in claim 20, further comprising:
advertising the negotiated orthogonal frequency hopping sequence to neighbor nodes of at least the receiver.

22. The method as in claim 1, further comprising:
selecting the sender as a parent node for the receiver in a directed acyclic graph (DAG) based on an ability of the parent node to use the orthogonal frequency hopping sequence.

23. An apparatus, comprising:
one or more wireless network interfaces configured to communicate in a frequency hopping wireless network;
a processor coupled to the wireless network interfaces and adapted to execute one or more processes; and
a network interface module coupled to the processor and the wireless network interfaces, the network interface module configured to:
receive an indication that a message from a sender is a large message, the indication to request use of an orthogonal frequency hopping sequence with the sender for the duration of the large message transmission, the orthogonal frequency hopping sequence orthogonal to a shared frequency hopping sequence of the wireless network;
receive the large message from the sender on the orthogonal frequency hopping sequence; and
return to the shared frequency hopping sequence upon completion of the large message transmission.

24. The apparatus as in claim 23, wherein the indication comprises an orthogonal rendezvous request message from the sender prior to the sender transmitting the large message, wherein the network interface module is further configured to:
return an acknowledgment to the sender that the network interface module can comply with the request.

25. A tangible, non-transitory, computer-readable media having software encoded thereon, the software when executed by a processor on a device in a frequency hopping wireless network operable to:
receive an indication that a message from a sender is a large message, the indication to request use of an orthogonal frequency hopping sequence with the sender for the duration of the large message transmission, the orthogonal frequency hopping sequence orthogonal to a shared frequency hopping sequence of the wireless network;
receive the large message from the sender on the orthogonal frequency hopping sequence; and
return to the shared frequency hopping sequence upon completion of the large message transmission.
